(19) United States
(12) Patent Application Publication
(10) Pub. No.: US 2005/0157854 A1
(43) Pub. Date: Jul. 21, 2005

(54) Telephone recording system

(76) Inventors: Chi Wah Lo, Hong Kong (HK); Tai Kwan Tang, Hong Kong (HK); Hwai Sian Tsai, Hong Kong (HK); Wing Cheong Chan, Hong Kong (HK)

Correspondence Address: ALIX YALE & RISTAS LLP, 750 MAIN STREET, SUITE 1400, HARTFORD, CT, 06103, US

(21) Appl. No.: 10/758,850

(22) Filed: Jan. 16, 2004

(51) Int. Cl. H04M 1/64

(52) U.S. Cl. 379/67.1; 379/77

(57) ABSTRACT

A recording system for a Private Branch Automatic Exchange (PBAX) comprises a recording unit for recording a telephone conversation on the public line side of the PBAX and coding units for connecting to private lines of the PBAX and for identifying to the recording unit the private line in use. The recording unit may include a transformer for detecting a telephone conversation signal, a processor and a storage medium.

### BACKGROUND TO THE INVENTION

1. Field of the Invention

The current invention relates to telephone conversation recording systems and in particular to a recording system for a Private Branch Automatic Exchange (PABX).

2. Background Information

Telephone conversation recording is crucial to financial institutions, call centers and service centers. Such organizations use a Private Branch Automatic Exchange (PABX) to connect a large number of internal telephone lines to a smaller number of public telephone lines.

FIG. 1 illustrates a prior art telephone recording system for use in a PABX telephone system. The recording system records from each of the internal lines of the PABX system. The recording system must have a recording channel for each of the internal lines even though the actual number of real telephone lines is much smaller. A recording system for a large PABX system can be very expensive, for example a recording system with 128 recording channels might cost in the order of US$130,000.

Furthermore, each PABX system employs a proprietary format and therefore recording systems must be designed specifically for the PABX system and are not portable.

### SUMMARY OF THE INVENTION

It is an object of the present invention to provide a recording system for a PABX that overcomes or ameliorates the above disadvantages.

To overcome the above problems a recording system for a PABX records telephone conversations directly from public telephone lines. A code generator is attached to each PABX internal phone line to identify each particular telephone call. The code generator will generate a code identifying the phone line in use using a spread spectrum or DTMF method. The code is recorded with the telephone conversation to identify it.

According to a first aspect of the invention there is provided a recording system for a Private Branch Automatic Exchange comprising;
a recording unit for recording a telephone conversation on a public telephone line side of a Private Branch Automatic Exchange, and
a plurality of coding units for connecting to private lines of the Private Branch Automatic Exchange and for identifying to the recording unit the private line in use.

Preferably, the recording unit comprises a transformer for detecting a telephone conversation signal on the public telephone line and producing a recording signal, a processor for manipulating the recording signal and a storage medium for the recording.

Preferably, the processor comprises a Coder/Decoder and a Digital Signal Processor.

Preferably, the coding unit comprises a pick-up detector for determining when a phone line is in use, and a processor for communicating line in use information to the recording unit.

According to a second aspect of the invention there is provided a method of recording a telephone conversation on a Public Branch Automatic Exchange comprising:
providing a recording unit for recording a telephone conversation on a public telephone line side of a Private Branch Automatic Exchange,
providing a coding unit for identifying the private line of the Private Branch Automatic Exchange in use and communicating line in use information to the recording unit, and
recording the line in use information with the telephone conversation.

Preferably, the method includes communicating line in use information using a Dual Tone Multi Frequency method.

Further aspects of the invention will become apparent from the following description, which is given by way of example only.

### BRIEF DESCRIPTION OF THE DRAWINGS

Embodiments of the invention will now be described with reference to the accompanying drawings in which:

FIG. 1 illustrates a prior art telephone recording system,

FIG. 2 illustrates a telephone recording system according to the invention,

FIG. 3 illustrates parts of the recording system,

FIG. 4 illustrates operational steps of the recording system, and

FIG. 5 is a table of DTMF frequencies.

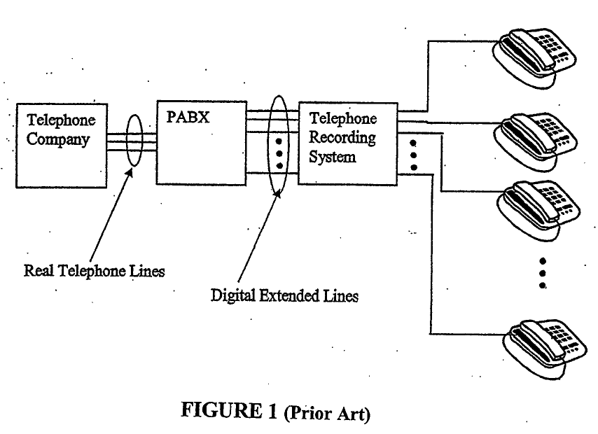

### DESCRIPTION OF THE PREFERRED EXAMPLE

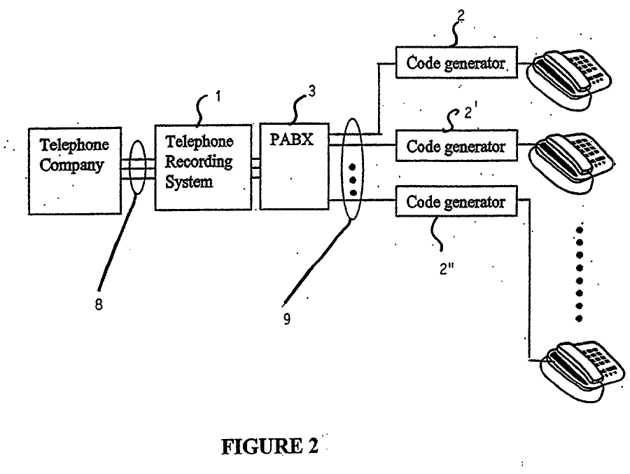

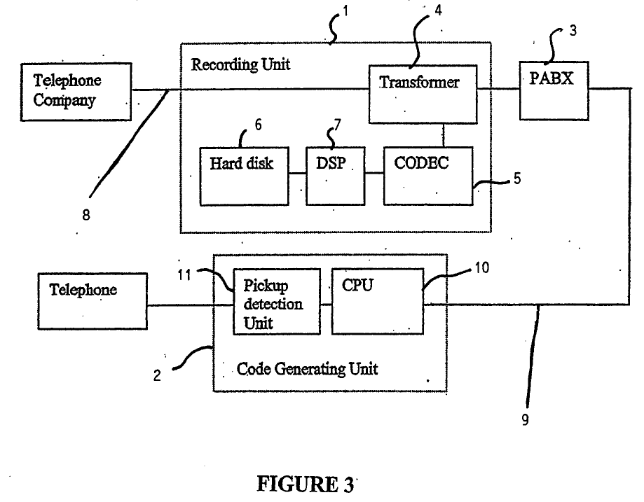

Referring to FIGS. 2 and 3, a preferred example of a recording system consisting of a recording unit 1 and a plurality of code generating units 2. The recording unit 1 is located on the public telephone line 8 side of a Private Branch Automatic Exchange (PABX) 3. A code generating unit 2 is located on each private line 9 of the Private Branch Automatic Exchange.

The recording unit 1 comprises a transformer 4, a coder/decoder (CODEC) 5, a hard disk 6 and a Digital Signal Processor (DSP) 7. The transformer 4 converts high voltage analog signal from public telephone lines 8 to low voltage analog signal input to the CODEC 5. The CODEC 5 converts the analog signal to a digital signal. The DSP 7 is responsible for decoding codes from the code generating unit 2 and storing telephone conversation on to a the hard disk 6.

The code generating unit 2 comprises a CPU 10 and a pick-up detection unit 11.

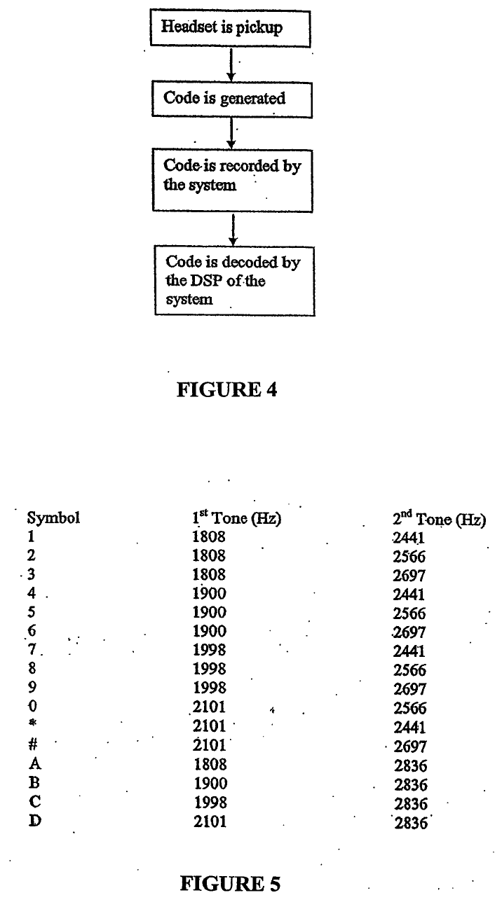

Referring to FIG. 4, the code generating unit 2 is responsible for generating code using a spread spectrum or Dual Tone Multi Frequency (DTMF) method to identify which of the private lines 9 of the Private Branch Automatic Exchange is in use. When a telephone call is made or received, the CPU 10 will generate a code to identify the telephone line and transmit the code to the DSP 7 of the recording unit 1 via the telephone lines.

The code can be in two formats. The first method uses DTMF. A code comprises an identifier e.g. 12345. Each character of the code is represented by low and high frequencies as shown in the table of FIG. 5. The DTMF method is well known and need not be described in further detail.

The second format uses a series of digital data as the code. The CPU 10 spreads the code over a wide spectrum of the telephone line frequency so that it appears as background noise and the users cannot hear it. The DSP 7 then de-spreads the signal to the original code at the recording unit. The spreading factor is 256.

The advantage of the above system is that considerably less record channels are needed by the recording unit thus reducing costs and the recording system is compatible to all PABX systems.

Where in the foregoing description reference has been made to integers or elements having known equivalents, then such are included as if individually set forth herein.

Embodiments of the invention have been described, however it is understood that variations, improvement or modifications can take place without departure from the spirit of the invention or scope of the appended claims.

1. A recording system for a Private Branch Automatic Exchange comprising;
a recording unit for recording a telephone conversation on a public telephone line side of a Private Branch Automatic Exchange, and
a plurality of coding units for connecting to private lines of the Private Branch Automatic Exchange and for identifying to the recording unit the private line in use.

2. The recording system of claim 1 wherein the recording unit comprises a transformer for detecting a telephone conversation signal on the public telephone line and producing a recording signal, a processor for manipulating the recording signal and a storage medium for the recording.

3. The recording system of claim 2 wherein the processor comprises a Coder/Decoder and a Digital Signal Processor.

4. The recording system of claim 1 wherein the coding unit comprises a pick-up detector for determining when a phone line is in use, and a processor for communicating line in use information to the recording unit.

5. A method of recording a telephone conversation on a Public Branch Automatic Exchange comprising:
providing a recording unit for recording a telephone conversation on a public telephone line side of a Private Branch Automatic Exchange,
providing a coding unit for identifying the private line of the Private Branch Automatic Exchange in use and communicating line in use information to the recording unit, and
recording the line in use information with the telephone conversation.

6. The method of claim 5 wherein communicating line in use information uses a Dual Tone Multi Frequency method.
